(19) United States
(12) Patent Application Publication
(10) Pub. No.: US 2023/0080671 A1
(43) Pub. Date: Mar. 16, 2023

(54) USER INTENTION RECOGNITION METHOD AND APPARATUS BASED ON STATEMENT CONTEXT RELATIONSHIP PREDICTION

(71) Applicant: WIZ HOLDINGS PTE. LTD., Singapore (SG)

(72) Inventor: Yangyang GAO, Nanjing (CN)

(21) Appl. No.: 17/802,109

(22) PCT Filed: Feb. 2, 2021
(86) PCT No.: PCT/CN2021/074788

§ 371 Date: Aug. 24, 2022

(30) Foreign Application Priority Data
Feb. 25, 2020 (CN) 202010116553.9

(51) Int. Cl. G06F 40/35; G06F 40/279

(52) U.S. Cl. CPC G06F 40/35; G06F 40/279

(57) ABSTRACT

A user intention recognition method and apparatus based on statement context relationship prediction, and a computer device and a storage medium. The method comprises: setting a plurality of sample data, the sample data comprising a first statement, a second statement, and the statement attribute features and positional relationship of the first statement and the second statement (S10); inputting each piece of sample data into a pre-training language model for pre-training, and when the recognition accuracy of the pre-training language model for the sample data reaches a first set accuracy, determining an initial model according to the current operating parameters of the pre-training language model (S20); inputting a test statement into the initial model to predict the next statement of the test statement as a unique target to finely adjust the initial model, and when the prediction accuracy of the initial model reaches a second set accuracy, determining an intention recognition model according to the current operating parameters of the initial model (S30); and determining, by using the intention recognition model, the next statement of a statement input by a user, and determining a user intention according to the determined next statement (S40). Therefore, the determined user intention has relatively high accuracy.

### CROSS-REFERENCE TO RELATED APPLICATIONS

The present disclosure claims priority of a Chinese Patent Application No. 202010116553.9, filed with the Chinese National Intellectual Property Administration on Feb. 25, 2020, titled ‘METHOD AND APPARATUS FOR RECOGNIZING USER INTENTION BASED ON SENTENCE CONTEXT PREDICTION’, which is incorporated herein by reference in its entirety for all purposes.

### TECHNICAL FIELD

The present disclosure relates to the technical field of speech signal processing, and in particular, to a method, an apparatus, a computer device and a storage medium for recognizing user intention based on sentence context prediction.

### BACKGROUND OF THE INVENTION

With the development of artificial intelligence, intelligent dialogue robots have been widely used in people's daily life. These intelligent dialogue robots need to have a natural dialogue with a user, understand semantics of the user's speech, and accurately recognize the user's intention, so as to interact with the user more efficiently and realistically. In a dialogue system of the intelligent dialogue robot, whether the recognition of the user's intention is accurate determines whether the dialogue system can generate reasonable responses, which is the most important reflection of whether the dialogue system is intelligent.

At present, methods for intention recognition of user semantics are respectively based on keywords, based on regular expressions, based on rule templates, based on traditional machine learning such as support vector machines, and based on the current booming deep learning, and so on. For example, there is a solution that proposes an intention recognition method based on text similarity, so as to solve the problem of incorrect intention recognition caused by errors in converting speech to text. The calculation method of text similarity used in the solution includes an algorithm based on edit distance between strings and an algorithm based on the similarity of phrase vectors obtained by deep learning. There is another solution that proposes to train a deep learning model for intention recognition by combining feature vectors of words and spelling. It converts data sets in all fields into word sequences and corresponding spelling sequences, and inputs them into a first deep learning network to be get trained, so as to obtain a language model and initialize and update the coding layer parameter matrix of the language model, and further inputs them into a second deep learning network to obtain the encoded word sequences and spelling sequences, which are weighted and inputted into the second deep learning network again to train the intention recognition model, and so on. However, traditional user intention recognition solutions often suffer from low accuracy.

### SUMMARY OF THE INVENTION

Based on this, the purpose of the present disclosure is to provide a method, an apparatus, a computer device and a storage medium for recognizing user intention based on sentence context prediction, which can improve the accuracy of user intention recognition.

In order to achieve the above purpose, the present disclosure provides a method for recognizing user intention based on sentence context prediction. The method for recognizing user intention based on sentence context prediction may include: S10, setting a plurality of sample data; the sample data comprising a first sentence, a second sentence, sentence attribute features of the first sentence, sentence attribute features of the second sentence, and a positional relationship of the first sentence and the second sentence; S20, inputting each of the sample data into a pre-training language model to perform pre-training, and in response to that a recognition accuracy rate of the pre-training language model for the sample data reaches a first setting accuracy rate, determining an initial model based on current operating parameters of the pre-training language model; S30, inputting a test sentence into the initial model, fine-tuning the initial model with predicting a next sentence of the test sentence as a unique target, and in response to that a prediction accuracy rate of the initial model reaches a second setting accuracy rate, determining an intention recognition model based on current operating parameters of the initial model; and S40, determining, by using the intention recognition model, a next sentence of a sentence input by the user, and determining user intention according to the determined next sentence.

In some embodiments, the setting the plurality of sample data may include: acquiring multiple sets of sentences and setting a word embedding vector, an identification embedding vector and a position embedding vector of each word in each set of the multiple sets of sentences; and determining the sample data based on each set of sentences and word embedding vectors, identification embedding vectors and position embedding vectors respectively corresponding to the each set of sentences; wherein each set of sentences comprises the first sentence and the second sentence; the word embedding vector represents content of a corresponding word; the identification embedding vector represents that the corresponding word belongs to the first sentence or the second sentence; the position embedding vector represents a position of the corresponding word in the sentence.

In some embodiments, the determining, by using the intention recognition model, the next sentence of the sentence input by the user may include: reading the sentence input by the user, and inputting the sentence input by the user into the intention recognition model, wherein a plurality of candidate sentences and a probability value of each of the plurality of candidate sentences are inputted in the intention recognition model, and the candidate sentence with a largest probability value is determined as the next sentence of the sentence input by the user.

The present disclosure provides an apparatus for recognizing user intention based on sentence context prediction. The apparatus for recognizing user intention based on sentence context prediction may include: a setting module configured to set a plurality of sample data; the sample data comprising a first sentence, a second sentence, sentence attribute features of the first sentence, sentence attribute features of the second sentence, and a positional relationship of the first sentence and the second sentence; a pre-training module configured to input each of the sample data into a pre-training language model to perform pre-training, and in response to that a recognition accuracy rate of the pre-training language model for the sample data reaches a first setting accuracy rate, determine an initial model based on current operating parameters of the pre-training language model; a fine-tuning module configured to input a test sentence into the initial model, fine-tune the initial model with predicting a next sentence of the test sentence as a unique target, and in response to that a prediction accuracy rate of the initial model reaches a second setting accuracy rate, determine an intention recognition model based on current operating parameters of the initial model; and a determining module configured to determine, by using the intention recognition model, a next sentence of a sentence input by the user, and determine user intention according to the determined next sentence.

In some embodiments, the setting module is further configured to: acquire multiple sets of sentences and set a word embedding vector, an identification embedding vector and a position embedding vector of each word in each set of the multiple sets of sentences; and determine the sample data based on each set of sentences and word embedding vectors, identification embedding vectors and position embedding vectors respectively corresponding to the each set of sentences; wherein each set of sentences comprises the first sentence and the second sentence; the word embedding vector represents content of a corresponding word; the identification embedding vector represents that the corresponding word belongs to the first sentence or the second sentence; the position embedding vector represents a position of the corresponding word in the sentence.

In some embodiments, the determining module is further configured to read the sentence input by the user, and input the sentence input by the user into the intention recognition model, wherein a plurality of candidate sentences and a probability value of each of the plurality of candidate sentences are inputted in the intention recognition model, and the candidate sentence with a largest probability value is determined as the next sentence of the sentence input by the user.

The present disclosure provides a computer device, comprising a memory, a processor and computer programs stored in the memory and running on the processor, when the computer programs are executed by the processor, the steps of the method for recognizing user intention based on sentence context prediction are implemented.

The present disclosure provides a computer-readable storage medium on which computer programs are stored, and when the computer programs are executed by a processor, the steps of the method for recognizing user intention based on sentence context prediction are implemented.

According to the specific embodiments provided by the present disclosure, the present disclosure discloses the following technical effects.

The present disclosure provides a method, an apparatus, a computer device and a storage medium for recognizing user intention based on sentence context prediction. By setting a plurality of sample data; inputting each of sample data into a pre-training language model for pre-training; in response to that a recognition accuracy rate of the pre-training language model for the sample data reaches a first setting accuracy rate, determining an initial model based on current operating parameters of the pre-training language model; inputting a test sentence to the initial model; fine-tuning the initial model with a prediction of a next sentence of the test sentence as a unique target; in response to that an prediction accuracy rate of the initial model reaches a second setting accuracy rate, determining an intention recognition model based on current operating parameters of the initial model; determining the next sentence of a sentence input by the user by using the intention recognition model; and determining user intention based on the determined next sentence, the determined user intention has higher accuracy.

### BRIEF DESCRIPTION OF THE DRAWINGS

In order to more clearly illustrate the embodiments of the present disclosure or the technical solutions in the prior art, the accompanying drawings required in the embodiments will be briefly introduced below. Obviously, the drawings in the following description are only some embodiments of the present disclosure. For those of ordinary skill in the art, other drawings can also be obtained according to these drawings without creative labor.

FIG. 1 is a flowchart of a method for recognizing user intention based on sentence context prediction according to some embodiments of the present disclosure;

FIG. 2 is a schematic diagram of a sentence composition process according to some embodiments of the present disclosure;

FIG. 3 is a schematic diagram of a model and a training target during fine-tuning according to some embodiments of the present disclosure;

FIG. 4 is a schematic structural diagram of an apparatus for recognizing user intention based on sentence context prediction according to some embodiments of the present disclosure; and

FIG. 5 is a schematic diagram of a computer device according to some embodiments of the present disclosure.

### DETAILED DESCRIPTION OF THE INVENTION

The technical solutions in the embodiments of the present disclosure will be clearly and completely described below with reference to the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative efforts shall fall within the protection scope of the present disclosure.

The purpose of the present disclosure is to provide a method, an apparatus, a computer device and a storage medium for recognizing user intention based on sentence context prediction, which can improve the accuracy of user intention recognition.

In order to make the above objects, features and advantages of the present disclosure more clearly understood, the present disclosure will be described in further detail below with reference to the accompanying drawings and specific embodiments.

The method for recognizing user intention based on sentence context prediction provided by the present disclosure can be applied to terminals related to user intention recognition, such as robots that need to communicate with users, etc. The above-mentioned terminals related to user intention recognition can set a plurality of sample data; input each piece of sample data into a pre-training language model for pre-training; in response to that a recognition accuracy rate of the pre-training language model for the sample data reaches a first setting accuracy rate, determine an initial model based on current operating parameters of the pre-training language model; input a test sentence to the initial model; fine-tune the initial model with the prediction of a next sentence of the test sentence as a unique target; in response to that a prediction accuracy rate of the initial model reaches a second setting accuracy rate, determine an intention recognition model based on current operating parameters of the initial model; determine, by using the intention recognition model, a next sentence of a sentence input by the user; and determine user intention based on the determined next sentence, so that the accuracy of the determined user intention is improved. The terminals related to user intention recognition may be, but is not limited to, various smart processing devices such as personal computers and notebook computers, and so on.

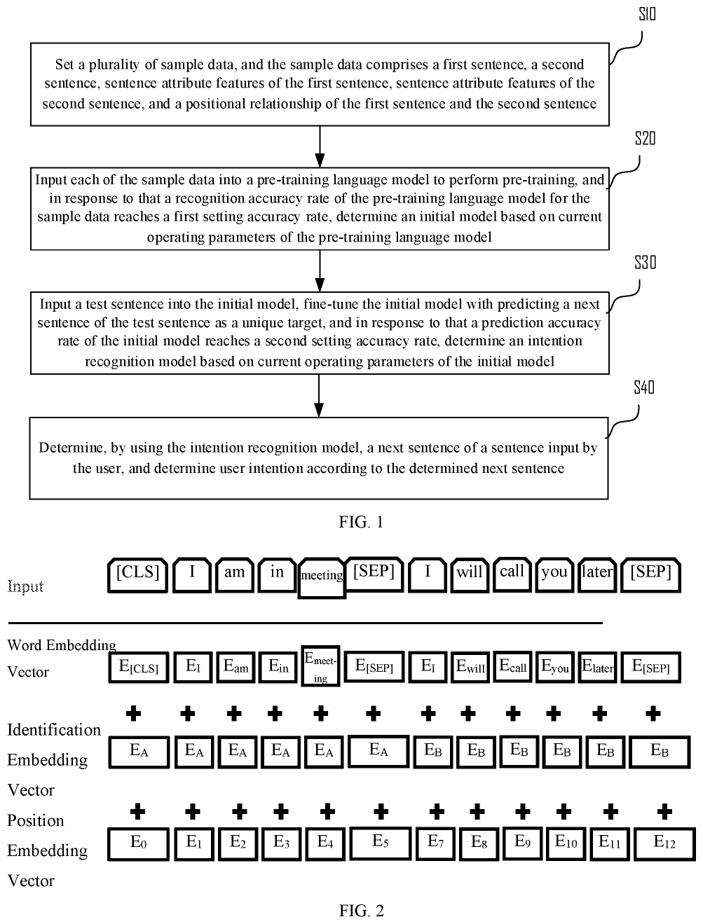

In some embodiments, as shown in FIG. 1, a method for recognizing user intention based on sentence context prediction is provided, and takes the method being applied to a terminal related to user intention recognition as an example to illustrate. The method includes the following steps.

At S10, a plurality of sample data is set; the sample data includes a first sentence, a second sentence, sentence attribute features of the first sentence, sentence attribute features of the second sentence, a positional relationship of the first sentence and the second sentence.

The above sentence attribute features include words included in a corresponding sentence, a position of each word, and the like.

In some embodiments, the setting the plurality of sample data includes: acquiring multiple sets of sentences, setting a word embedding vector, an identification embedding vector and a position embedding vector of each word in each set of the multiple sets of sentences, and determining sample data according to each set of sentences and word embedding vectors, identification embedding vectors and position embedding vectors respectively corresponding to the each set of sentences; wherein each set of sentences includes a first sentence and a second sentence; the word embedding vector represents content of a corresponding word; the identification embedding vector represents that the corresponding word belongs to the first sentence or the second sentence; the position embedding vector represents a position of the corresponding word in the sentence.

In some embodiments, each of the above sets of sentences includes a first sentence and a second sentence, and the first sentence may be a previous sentence of a corresponding set of sentences, and the second sentence may be a latter sentence of the corresponding set of sentences.

Furthermore, the above-mentioned sample data is used as an input of a subsequent pre-training language model, wherein a first label of each sequence can always be a classification label corresponding to the sequence. A final output hidden state corresponding to such label is used to indicate whether the second sentence is the next sentence of the first sentence. The first sentence and second sentence can be packaged together to form a single sequence and treat as a set of sentences.

In some embodiments, sentences can be distinguished in two ways. The first way is to use special symbols, such as ‘[SEP]’, to separate them. The second way is to add a learned identification embedding vector to each word to indicate whether it belongs to sentence A (i.e., the first sentence) or sentence B (i.e., the second sentence). For each word, the input of the model is obtained by adding the word embedding vector, the identification embedding vector (E_{A}, E_{B}) and the position embedding vector (E₀, E₁, E₂, . . . ) of the word itself. The specific process can be referred to FIG. 2.

At S20, each of the sample data is input into a pre-training language model to perform pre-training, and in response to that a recognition accuracy rate of the pre-training language model for the sample data reaches a first setting accuracy rate, an initial model is determined based on current operating parameters of the pre-training language model.

The above-mentioned first setting accuracy rate may be set according to the accuracy of user recognition, for example, set to a value such as 98%.

In some embodiments, the pre-training refers to training using a large-scale monolingual corpus that is independent of the dialogue system. The corresponding model, such as a pre-training language model, is pre-trained by using two tasks as targets. The first task is to perform a masking operation on the language model, which means randomly mask a certain proportion of words at the input of the model, and then predict these masked words at the output of the model, so as to build a bidirectional deep network. The second task is to predict whether the second sentence is the next sentence. When choosing two sentences for each pre-training sample, there is a fifty percent probability that the second sentence is the actual next sentence following the first sentence, and a fifty percent probability that the second sentence is a random sentence from the corpus.

At S30, a test sentence is input into the initial model, and the initial model is fine-tuned with a unique target of predicting the next sentence of the test sentence, and in response to that a prediction accuracy rate of the initial model reaches a second setting accuracy rate, an intention recognition model is determined based on current operating parameters of the initial model.

The above-mentioned second setting accuracy rate may be set according to the accuracy of user recognition, for example, set to a value such as 98%.

In some embodiments, after the pre-training is completed, the pre-trained model is fine-tuned using the sentences configured by the dialogue system. At the fine-tuning stage, performing the masking operation on the language model is no longer the training target, but only predicting the next sentence is treated as the unique target, so the model no longer masks any words at the input. The samples in the fine-tuning stage are generated as follows: positive samples in the task training set are generated by taking the sentence that the user is expected to speak as a first sentence and taking the sentence of the next node configured in the dialogue system as a second sentence; and negative samples in the task training set are generated by taking the sentence that the user is expected to speak as a first sentence and taking the sentence of the other node configured in the dialogue system as a second sentence.

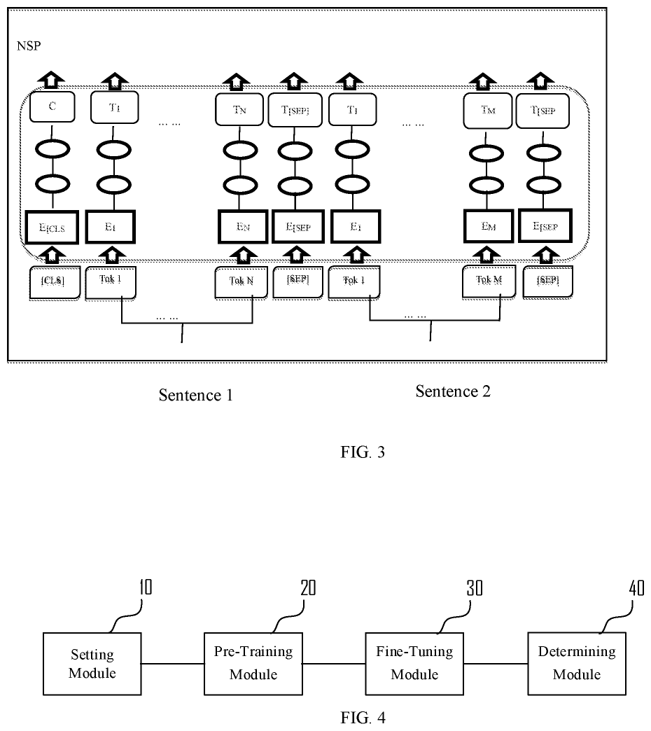

In some embodiments, the model and the training target during fine-tuning are shown in FIG. 3.

At S40, the next sentence of a sentence input by the user is determined using the intention recognition model, and user intention is determined according to the determined next sentence.

In some embodiments, the determining, by using the intention recognition model, the next sentence of the sentence input by the user includes: reading the sentence input by the user, and inputting the sentence input by the user into the intention recognition model, wherein a plurality of candidate sentences and a probability value of each of the plurality of candidate sentences are inputted in the intention recognition model, and the candidate sentence with a largest probability value is determined as the next sentence of the sentence input by the user.

In the actual man-machine dialogue process, the prediction method of the corresponding model, i.e., the intention recognition model, is performed respectively by taking the sentence actually spoken by the user as the first sentence and taking each of all branch sentences of the current node as the second sentence, so as to obtain a respective probability of each of all branch sentences being the next sentence to the sentence spoken by the user. The branch where the sentence with the highest probability is located is taken as the matched intention, and the sentence with the highest probability is returned as a reply.

Furthermore, at the prediction phase, the model also no longer masks any words at the input.

According to the above-mentioned method for recognizing user intention based on sentence context prediction, by setting a plurality of sample data; inputting each of sample data into a pre-training language model for pre-training; in response to that a recognition accuracy rate of the pre-training language model for the sample data reaches a first setting accuracy rate, determining an initial model based on current operating parameters of the pre-training language model; inputting a test sentence to the initial model; fine-tuning the initial model with a prediction of a next sentence of the test sentence as a unique target; in response to that an prediction accuracy rate of the initial model reaches a second setting accuracy rate, determining an intention recognition model based on current operating parameters of the initial model; determining the next sentence of a sentence input by the user by using the intention recognition model; and determining user intention based on the determined next sentence, the determined user intention has higher accuracy.

In some embodiments, in the application process of the above-mentioned method for recognizing user intention based on sentence context prediction, the pre-training for language model is very effective in improving many natural language processing tasks. These tasks include sentence-level tasks as well as word-level tasks, such as natural language inference, named entity recognition, and knowledge question & answer for predicting relationships between sentences. Transformer-based Bidirectional Encoding Representation (BERT) is a recently proposed pre-training language model. The pre-training language model can efficiently extract text information and apply it to various natural language processing tasks. Its emergence refreshed the best performance records for 11 natural language processing tasks. In order to train a model that can understand the relationship between sentences, BERT proposes the task of training and predicting the next sentence from any monolingual corpus. That is, judging whether two sentences should be consecutive sentences with contextual relation. When choosing two sentences for each pre-training sample, there is a fifty percent probability that the second sentence is the actual next sentence following the first sentence, and a fifty percent probability that the second sentence is a random sentence from the corpus, i.e. the second sentence is not actually the next sentence of the first sentence. When training the bidirectional representation of the deep neural network, in order not to let each word affect the attention mechanism, BERT randomly masks a certain proportion of the input words, and then predicts the masked words. The present disclosure uses whether the two sentences should be consecutive sentences with contextual relation as a judgment basis for intention recognition, thereby improving the accuracy of intention recognition. Specifically, positive samples in the task training set are generated by taking the sentence that the user is expected to speak as a first sentence and taking the sentence of the next node configured in the dialogue system as a second sentence; and negative samples in the task training set are generated by taking the sentence that the user is expected to speak as a first sentence and taking the sentence of the other node configured in the dialogue system as a second sentence. After the positive samples and the negative samples are generated, it is to continue to train and fine-tune the BERT pre-training model based on this data until the loss value of the model converges. In the actual man-machine dialogue process, the prediction method of the model is executed respectively by taking a sentence actually spoken by the user as the first sentence, and taking each of all branch sentences of the current node as the second sentence, and a probability that each sentence is treated as the next sentence after the sentence spoken by the user is obtained. The branch where the sentence with the highest probability is located is taken as the matched intention, and the sentence with the highest probability is returned as the reply.

Referring to FIG. 4, FIG. 4 is a schematic structural diagram of an apparatus for recognizing user intention based on sentence context prediction according to some embodiments. The apparatus may include a setting module 10, a pre-training module 20, a fine-tuning module 30 and a determining module 40.

The setting module 10 is configured to set a plurality of sample data. The sample data includes a first sentence, a second sentence, sentence attribute features of the first sentence, sentence attribute features of the second sentence, and a positional relationship of the first sentence and the second sentence.

The pre-training module 20 is input each of the sample data into a pre-training language model to perform pre-training, and in response to that a recognition accuracy rate of the pre-training language model for the sample data reaches a first setting accuracy rate, determine an initial model based on current operating parameters of the pre-training language model.

The fine-tuning module 30 is configured to input a test sentence into the initial model, fine-tune the initial model with predicting a next sentence of the test sentence as a unique target, and in response to that a prediction accuracy rate of the initial model reaches a second setting accuracy rate, determine an intention recognition model based on current operating parameters of the initial model.

The determining module 40 is configured to determine, by using the intention recognition model, a next sentence of a sentence input by the user, and determine user intention according to the determined next sentence.

In one embodiment, the setting module 10 is further configured to acquire multiple sets of sentences and setting a word embedding vector, an identification embedding vector and a position embedding vector of each word in each set of the multiple sets of sentences; and determine the sample data based on each set of sentences and word embedding vectors, identification embedding vectors and position embedding vectors respectively corresponding to the each set of sentences; wherein each set of sentences comprises the first sentence and the second sentence; the word embedding vector represents content of a corresponding word; the identification embedding vector represents that the corresponding word belongs to the first sentence or the second sentence; the position embedding vector represents a position of the corresponding word in the sentence.

In one embodiment, the determining module 40 is further configured to read the sentence input by the user, and input the sentence input by the user into the intention recognition model, wherein a plurality of candidate sentences and a probability value of each of the plurality of candidate sentences are inputted in the intention recognition model, and the candidate sentence with a largest probability value is determined as the next sentence of the sentence input by the user.

For the specific limitation of apparatus for recognizing user intention based on sentence context prediction, refer to the above limitation on the method for recognizing user intention based on sentence context prediction, which will not be repeated here. Each module in the above-mentioned apparatus for recognizing user intention based on sentence context prediction can be implemented in whole or in part by software, hardware, and combinations thereof. The above modules can be embedded in or independent of the processor in the computer device in the form of hardware, or stored in the memory in the computer device in the form of software, so that the processor can call and execute the operations corresponding to the above modules.

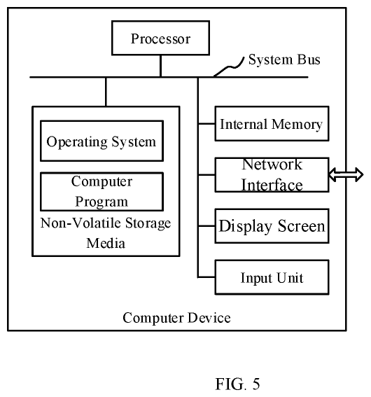

In some embodiments, a computer device is provided, and the computer device may be a terminal, and its internal structure diagram may be as shown in FIG. 5. The computer device includes a processor, a memory, a network interface, a display screen, and an input unit connected by a system bus. Among them, the processor of the computer device is used to provide computing and control capabilities. The memory of the computer device includes a non-volatile storage medium and an internal memory. The non-volatile storage medium stores an operating system and computer programs. The internal memory provides an environment for the execution of the operating system and computer programs in the non-volatile storage medium. The network interface of the computer device is used to communicate with an external terminal through a network connection. When the computer programs are executed by the processor, the method for recognizing user intention based on sentence context prediction is implemented. The display screen of the computer device may be a liquid crystal display screen or an electronic ink display screen, and the input unit of the computer device may be a touch layer covered on the display screen, or a button, a trackball or a touchpad set on the shell of the computer device, or an external keyboard, track-pad, or mouse.

Those skilled in the art can understand that the structure shown in FIG. 5 is only a block diagram of a part of the structure related to the solution of the present disclosure, and does not constitute a limitation on the computer device to which the solution of the present application is applied. The specific computer device may include more or fewer components than shown in the figures, or combine certain components, or have a different arrangement of components.

Based on the examples described above, in one embodiment there is also provided a computer device comprising a memory, a processor and computer programs stored on the memory and executable on the processor, wherein when the computer programs are executed by the processor, the steps of any one of the methods for recognizing user intention based on sentence context prediction in the above-mentioned embodiments are implemented.

Those of ordinary skill in the art can understand that all or part of the processes in the methods of the above embodiments can be implemented by instructing relevant hardware through a computer program, and the program can be stored in a non-volatile computer-readable storage medium. In embodiments of the present disclosure, the program may be stored in a storage medium of a computer system, and executed by at least one processor in the computer system, so as to implement the process of the above-mentioned method for recognizing user intention based on sentence context prediction. The storage medium may be a magnetic disk, an optical disk, a read-only memory (ROM), or a random access memory (RAM) or the like.

Accordingly, in one embodiment, there is also provided a computer storage medium, a computer readable storage medium, on which a computer program is stored, wherein, when the program is executed by a processor, any one of the methods for recognizing user intention based on sentence context prediction in the above-mentioned embodiments is implemented.

The principles and implementations of the present disclosure are described herein using specific examples. The descriptions of the above embodiments are only used to help understand the method and the core idea of the present disclosure. Meanwhile, for those skilled in the art, according to the present disclosure, there will be changes in the specific implementation and scope of the present disclosure. In conclusion, the contents of this specification should not be construed as limiting the present disclosure.

1. A method for recognizing user intention based on sentence context prediction, comprising:
S10: setting a plurality of sample data, the sample data comprising a first sentence, a second sentence, sentence attribute features of the first sentence, sentence attribute features of the second sentence, and a positional relationship of the first sentence and the second sentence;
S20: inputting each of the sample data into a pre-training language model to perform pre-training, and in response to that a recognition accuracy rate of the pre-training language model for the sample data reaches a first setting accuracy rate, determining an initial model based on current operating parameters of the pre-training language model;
S30: inputting a test sentence into the initial model, fine-tuning the initial model with predicting a next sentence of the test sentence as a unique target, and in response to that a prediction accuracy rate of the initial model reaches a second setting accuracy rate, determining an intention recognition model based on current operating parameters of the initial model; and
S40: determining, by using the intention recognition model, a next sentence of a sentence input by the user, and determining user intention according to the determined next sentence.

2. The method for recognizing user intention based on sentence context prediction according to claim 1, wherein the setting the plurality of sample data comprises:
acquiring multiple sets of sentences and setting a word embedding vector, an identification embedding vector and a position embedding vector of each word in each set of the multiple sets of sentences; and
determining the sample data based on each set of sentences and word embedding vectors, identification embedding vectors and position embedding vectors respectively corresponding to the each set of sentences;
wherein each set of sentences comprises the first sentence and the second sentence; the word embedding vector represents content of a corresponding word; the identification embedding vector represents that the corresponding word belongs to the first sentence or the second sentence; the position embedding vector represents a position of the corresponding word in the sentence.

3. The method for recognizing user intention based on sentence context prediction according to claim 2, wherein the determining, by using the intention recognition model, the next sentence of the sentence input by the user comprises:
reading the sentence input by the user, and inputting the sentence input by the user into the intention recognition model,
wherein a plurality of candidate sentences and a probability value of each of the plurality of candidate sentences are inputted in the intention recognition model, and the candidate sentence with a largest probability value is determined as the next sentence of the sentence input by the user.

4. A computing device for recognizing user intention based on sentence context prediction, comprising:
at least one processor; and
at least one memory communicatively coupled to the at least one processor and comprising computer-readable instructions that upon execution by the at least one processor cause the at least one processor to:
set a plurality of sample data, the sample data comprising a first sentence, a second sentence, sentence attribute features of the first sentence, sentence attribute features of the second sentence, and a positional relationship of the first sentence and the second sentence;
input each of the sample data into a pre-training language model to perform pre-training, and in response to that a recognition accuracy rate of the pre-training language model for the sample data reaches a first setting accuracy rate, determine an initial model based on current operating parameters of the pre-training language model;
input a test sentence into the initial model, fine-tune the initial model with predicting a next sentence of the test sentence as a unique target, and in response to that a prediction accuracy rate of the initial model reaches a second setting accuracy rate, determine an intention recognition model based on current operating parameters of the initial model; and
determine, by using the intention recognition model, a next sentence of a sentence input by the user, and determine user intention according to the determined next sentence.

5. The computing device for recognizing user intention based on sentence context prediction according to claim 4, wherein the computer-readable instructions that upon execution by the at least one processor further cause the at least one processor to:
acquire multiple sets of sentences and set a word embedding vector, an identification embedding vector and a position embedding vector of each word in each set of the multiple sets of sentences; and
determine the sample data based on each set of sentences and word embedding vectors, identification embedding vectors and position embedding vectors respectively corresponding to the each set of sentences;
wherein each set of sentences comprises the first sentence and the second sentence; the word embedding vector represents content of a corresponding word; the identification embedding vector represents that the corresponding word belongs to the first sentence or the second sentence; the position embedding vector represents a position of the corresponding word in the sentence.

6. The computing device for recognizing user intention based on sentence context prediction according to claim 4, wherein the computer-readable instructions that upon execution by the at least one processor further cause the at least one processor to:
read the sentence input by the user, and input the sentence input by the user into the intention recognition model,
wherein a plurality of candidate sentences and a probability value of each of the plurality of candidate sentences are inputted in the intention recognition model, and the candidate sentence with a largest probability value is determined as the next sentence of the sentence input by the user.

7. (canceled)

8. A non-transitory computer-readable storage medium on which computer programs are stored, wherein the computer programs are executed by a processor to cause the processor to implement operations comprising:
setting a plurality of sample data, the sample data comprising a first sentence, a second sentence, sentence attribute features of the first sentence, sentence attribute features of the second sentence, and a positional relationship of the first sentence and the second sentence;
inputting each of the sample data into a pre-training language model to perform pre-training, and in response to that a recognition accuracy rate of the pre-training language model for the sample data reaches a first setting accuracy rate, determining an initial model based on current operating parameters of the pre-training language model;
inputting a test sentence into the initial model, fine-tuning the initial model with predicting a next sentence of the test sentence as a unique target, and in response to that a prediction accuracy rate of the initial model reaches a second setting accuracy rate, determining an intention recognition model based on current operating parameters of the initial model; and
determining, by using the intention recognition model, a next sentence of a sentence input by the user, and determining user intention according to the determined next sentence.
